(19) United States
(12) Patent Application Publication
(10) Pub. No.: US 2014/0316908 A1
(43) Pub. Date: Oct. 23, 2014

(54) METHOD AND SYSTEM FOR PROVIDING REAL ESTATE PROPERTY INFORMATION WITH PROPERTY IMPROVEMENT/MAINTENANCE HISTORY

(71) Applicants: Jay Kalra, San Jose, CA (US); Anupam Awasthi, Saratoga, CA (US); Amol Awasthi, Dubai (AE)

(72) Inventors: Jay Kalra, San Jose, CA (US); Anupam Awasthi, Saratoga, CA (US); Amol Awasthi, Dubai (AE)

(21) Appl. No.: 14/256,718

(22) Filed: Apr. 18, 2014

Related U.S. Application Data
(60) Provisional application No. 61/813,581, filed on Apr. 18, 2013.

(51) Int. Cl. G06Q 50/16; G06F 17/30

(52) U.S. Cl. CPC G06Q 50/165; G06F 17/30554
USPC 705/14.73; 707/722; 706/12; 705/26.4

(57) ABSTRACT

Techniques for providing property information are described herein. According to one embodiment, a cloud-based platform at a server is provided to allow property owners to engage with property service providers regarding property improvement projects to be performed on the properties. Information describing tasks of the property improvement projects performed by the property service providers is recorded in a property history database. In response to a request received from a user for information concerning one of the properties, property improvement history data of the property is retrieved from the property history database. A property report is generated for the property, where the property report includes general multi-listing service (MLS) information and the property improvement history of the property.

### RELATED APPLICATIONS

This application claims the benefit of U.S. Provisional Patent Application No. 61/813,581, filed Apr. 18, 2013, which is incorporated by reference in its entirety.

### FIELD OF THE INVENTION

Embodiments of the present invention relate generally to real estate properties. More particularly, embodiments of the invention relate to providing real estate property information with property improvement/maintenance history.

### BACKGROUND

The Internet has changed the expectations of real estate buyers and sellers. Real estate buyers and sellers now demand more information and any information provided to be provided more quickly. In addition to changing the expectations of buyers and sellers of real estate in relation to speed and knowledge, the Internet has given buyers and sellers access to information that previously was available only through a real estate agent. For example, Internet services now allow real estate buyers and sellers to search MLS information by specifying property profiles.

Today, more and more buyers and sellers want very specific information concerning the properties they are interested in. Most of the Internet-based services provide general information about the properties that are typically available via public records, such as, for example, an address of the property, the year in which the property was built, a number of bedrooms and bathrooms, and school information of the property. However, some people, such as buyers, may also want to know, in addition to the purchase price, the property improvement records. For example, a potential buyer may want to know when the roof was replaced last time, such that the potential buyer has a rough idea when the current roof needs to be replaced. A potential buyer may also want to know whether there was termite or flood damage previously. These may factor in negotiating the purchasing price of the property, etc. The conventional MLS services are not capable of providing such information.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an example of system configuration for providing property information according to one embodiment of the invention.

FIG. 2 is a block diagram illustrating an example of a property improvement market place according to one embodiment of the invention.

FIG. 3 is a block diagram illustrating an example of a community platform according to one embodiment of the invention.

FIG. 4 is a block diagram illustrating an example of an advertisement platform according to one embodiment of the invention.

FIG. 5 is a flow diagram illustrating a method for providing property information including improvement history according to one embodiment of the invention.

FIG. 6 is a flow diagram illustrating a method for providing property information including improvement history according to one embodiment of the invention.

FIG. 7 is an example of a property report according to one embodiment of the invention.

FIGS. 8A-8J are block diagrams illustrating examples of graphical user interfaces provided by a server according to one embodiment of the invention.

FIGS. 9A-9D are block diagrams illustrating examples of graphical user interfaces according to another embodiment of the invention.

FIGS. 10A-10C are block diagrams illustrating examples of graphical user interfaces regarding communications between a property owner and a service provider according to one embodiment of the invention.

FIG. 11 is a block diagram illustrating an example of a data processing system which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Techniques for providing property information including property improvement records are described herein. According to some embodiments, a platform is provided to allow various users (e.g., property owners, service providers) to access property improvement records of various properties in different neighborhoods. In addition to maintain the general property related information, such as those provided by MLS services, the property improvement history of each of the properties hosted by the platform is maintained.

According to one embodiment, through a user interface (e.g., Web interface or application programming interface (API)), dependent upon their roles (e.g., property owners, service providers, general public members), users can search and browse the property improvement history of a property to some degrees, as well as other information that has been collected from various information sources (e.g., MLS sources). An analysis may be performed on at least some of the collected data. A report may be generated including general MLS information and the property improvement history. Furthermore, the platform also provides a market place to allow the property service providers and the property owners to engage to negotiate service contracts to perform further property improvement projects, which may also be recorded as part of the property improvement history. A property owner can post a property improvement project and multiple service providers can compete by submitting quotes or bids on the project. The service providers can also post advertisement or promotions of their services to solicit further business from the property owners.

Using the platform, property owners can maintain all their property-related data on the platform. They can store their property related equipments, information related to purchase, warranty, extended warranty (if applicable), create calendar events, review feedbacks of service providers, post property improvement projects, obtain bids from different service providers, provide feedbacks for service providers, receive answers to their questions related to property improvements, and post and browse neighborhood events, etc. Similarly, the contractors and other service providers can register themselves as service providers to showcase their work, seek reviews, provide quotes, bid on property improvement projects, post advertisements, and reach out to their neighborhood.

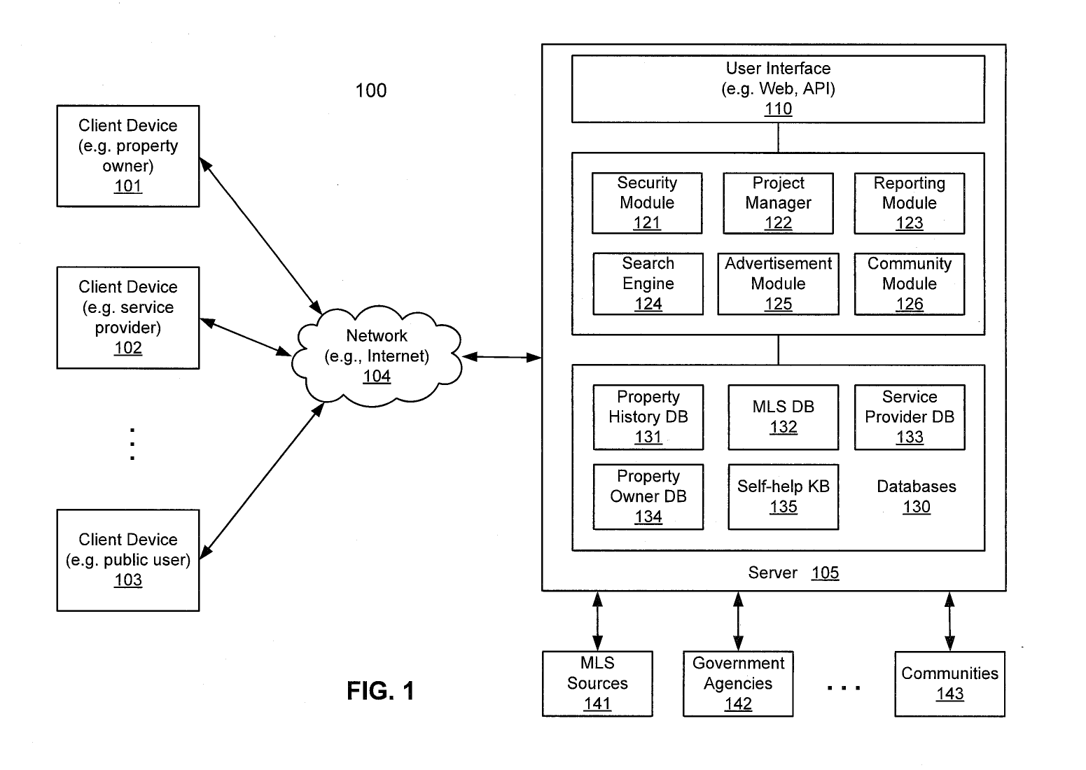

FIG. 1 is a block diagram illustrating an example of system configuration for providing property information according to one embodiment of the invention. Referring to FIG. 1, system 100 includes, but is not limited to, one or more client systems 101-103 communicatively coupled to server system 105 over network 104. Clients 101-103 may be any type of clients such as a personal computer (e.g., desktops, laptops, and tablets), a “thin” client, a personal digital assistant (PDA), a Web enabled appliance, or a mobile phone (e.g., Smartphone), etc. Network 104 may be any type of networks such as a local area network (LAN), a wide area network (WAN) such as the Internet, or a combination thereof, wired or wireless.

According to one embodiment, server 105 may be any kind of servers or a cluster of servers. For example, server 105 may be a cloud server providing real estate information over the Internet. Server 105 provides a platform, such as a Web-based platform, to allow various users (e.g., property owners, service providers represented by client systems 101-103) to access resources, such as information from databases 130, via user interface 110 of server 105. User interface 110 may be a Web interface to allow users with various roles to access the resources using a browser application. Alternatively, user interface 110 may an API that allows a client application, which may be running at any of client devices 101-103 to communicate with server 105.

The users who access server 105 may authenticated by security module 121 using a role-based authentication method. Users with different roles may be able to access different resources provided by server 105. For example, a property owner (e.g., a user represented by client device 101) can create a user account and register one or more properties with server 105. The information concerning the property owner, such as, for example, a username, password, and account settings, may be stored, for example, as a user profile, in property owner database 134. General MLS information concerning a registered property may be collected from the property owner or alternatively, retrieved from external MLS source 141. The MLS information may be cached or stored in MLS database 132. The MLS information may include, but is not limited, an address, city or county, number of bedrooms, number of bathrooms, year of build, and neighborhood information (e.g., schools), etc. When a property owner logs into its account, the property owner can retrieve the registered properties.

In addition, according to one embodiment, property improvement history and/or transaction history of a registered property may be stored in property history database 131. The property improvement history of a property refers to information or records describing or recording any jobs or tasks that have been performed on that particular property since the property has been built and/or occupied by a resident or tenant The recorded jobs performed on a property may include repairs, renovations, and/or additions. A property refers to a residential home, a commercial building, a piece of land, or a combination thereof.

The property jobs or projects of a registered property may be performed by one or more service providers who may also be clients of the system 105. Alternatively, a property owner may provide such information via user interface 110 to be stored in property history database 131. That is, a property owner may utilize the resources provided by server 105 record any property related activities or assets in property history database 131 (e.g., bookkeeping purposes). For example, a property owner may register property related equipment he/she purchased from a home improvement store and store the purchase receipt and/or warranty information in property history database 131 and/or property owner database 134.

According to one embodiment, a service provider (e.g., a user represented by client device 102), such as a home improvement contractor or handyman, can also create an account in server 105 to maintain service provider information in service provider database 133. The service provider information stored in service provider database 133 may include, but is not limited to, a username, password, expertise of the property improvement (e.g., roofs, floors, windows, termites), a working license, as well as user ratings and comments concerning the corresponding service provider, etc. A service provider may also be a real estate agent or broker that can provide property transaction services. For example, a real estate agent can create an account listing one or more properties that the real estate agent is current handling, which can include purchasing and selling of properties.

In one embodiment, the system has the ability for the contractor to store his work in the same system so they can manage projects that are not given to them via the system and that they received outside of the system from other sources, such as word-of-mouth and other promotions that they may have done. Making the system free to use incentivizes individuals to use the system, which provides the history of the property they are working on even though the original request was not generated by the property owner.

Furthermore, a general public member (e.g., a user represented by client device 103) can also browse via user interface 110 at least some publicly available information, dependent upon the specific settings of information providers (e.g., property owners, service providers). For example, a general public user can search a property or a category of properties using search engine 124. Similarly, a user can also search and obtain information concerning a particular service provider or a category of service providers. A search result may be sorted based on a variety of categories. The search result of service providers may be sorted based on the types of the memberships of the service providers. For example, a service provider may pay a specific fee to have its name to appear on the top of the search result. A user can also generate a report using reporting module 123 concerning a property or a service provider.

Furthermore, system 105 also provides a market place (not shown) to allow the property service providers and the property owners to engage to negotiate service contracts to perform further property improvement projects managed by project manager 122, which may also be recorded as part of property improvement history. A property owner can post a property improvement project and multiple service providers can provide quotes or bids on the project. The service providers can also post advertisement or promotions of their services, via advertisement module 125, to solicit further business from the property owners.

Using the platform provided by server 105, property owners can maintain all their property-related data on the platform. They can store their property related equipments or home appliances, information related to purchase, warranty, extended warranty (if applicable), create calendar events, review feedbacks of service providers, post property improvement projects, obtain bids from different service providers, provide feedbacks for service providers, receive answers to their questions related to property improvements, and post and browse neighborhood events, etc. Similarly, the contractors and other service providers can register themselves as service providers to showcase their work, seek reviews, provide quotes, bid on property improvement projects, post advertisements, and reach out to their neighborhood via community module 126.

In a further embodiment, server 105 may provide a self-learning platform to allow a user to browse self-learning knowledgebase (KB) 135 to obtain certain do-it-yourself (DIY) property improvement information. The information maintained by self-learning KB 135 may be provided by the service providers and/or property owners.

Note that service components or logic 120 may be implemented in software, hardware, or a combination of both. Databases 130 may be implemented as a single database or multiple databases maintained locally, remotely, or a combination of both. Information can be retrieved from a variety of information sources such as MLS sources 141, government agencies (e.g., city/county record department) 142, and/or local communities 143, etc.

In one embodiment, all (or some predetermined set or number of) the click-thru is recorded in the system. This is to record the “not-confirmed yet possible fixes” related to the primary property address. In one embodiment, the system records all (or some predetermined set or number of) the clicks within the portal for data analysis and also to provide individuals the “non-confirmed yet possible” fixes.

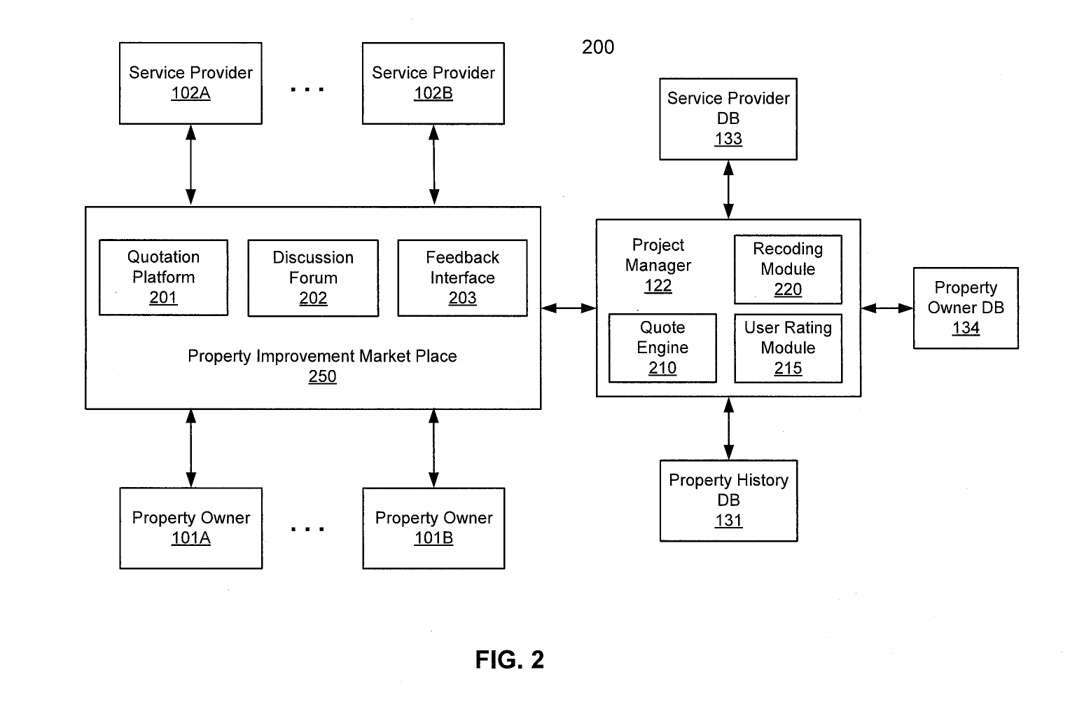

FIG. 2 is a block diagram illustrating an example of a property improvement market place according to one embodiment of the invention. System 200 may be hosted by server 105 of FIG. 1. Referring to FIG. 2, according to one embodiment, property improvement market place 250 is provided and managed by project manager 122 to allow property owners 101A-101B to post property improvement projects to solicit offers from service providers 102A-102B. Market place 250 may be provided in a form of a Web page that can be accessed by property owners 101A-101B and service providers 102A-102B.

In one embodiment, a property owner can list a specification of a property improvement project in market place 250. The specification may describe the type of project (e.g., roof, floor, kitchen, bathroom), the date to be completed, or other specific details, such as materials, etc. The posted projects can be viewed by the registered service providers 102A-102B. Market place 250 includes a quotation platform to allow any one of service providers 102A-102B to submit a quote or bid to the list projects, which may be handled by quote engine 210 of project manager 122. Prior to bidding or accepting an offer, a property owner and a service provider can also discuss or exchange further details via discussion forum 202 concerning a posted project. For example, a service provider may ask a question related to certain details of the specification and the property owner can provide additional information in response.

The project may be open for bidding for a predetermined period of time and once the bidding period ends, quote engine 210 provides the submitted quotes from the service providers to the corresponding property owners for selection. A property owner can then accept one or more offers from one or more of service providers 102A-102B. The selected service provider(s) can then perform the project on the property. The posting, bidding, and project activities may be recorded by recording module 220 and stored in property history database 131, service provider database 133, and/or property owner database 134. Once the project has been completed, a property owner can provide a feedback or user rating concerning the service provider that performed the project via feedback interface 203, which is handled by user rating module 215. Similarly, the service provider can also provide a feedback concerning the property owner. The feedbacks associated with a property owner and a service provider may be stored as part of the property owner database 134 and service provider database 133, respectively. The user ratings and/or comments of service providers and property owners can be displayed as part of detailed information of the service providers and/or property owners, for example, in response to a search request. Some of the ratings and/or comments of a service provider and/or a property owner may be publicly available to general public members, dependent upon the privacy settings of the corresponding service provider and/or the property owner.

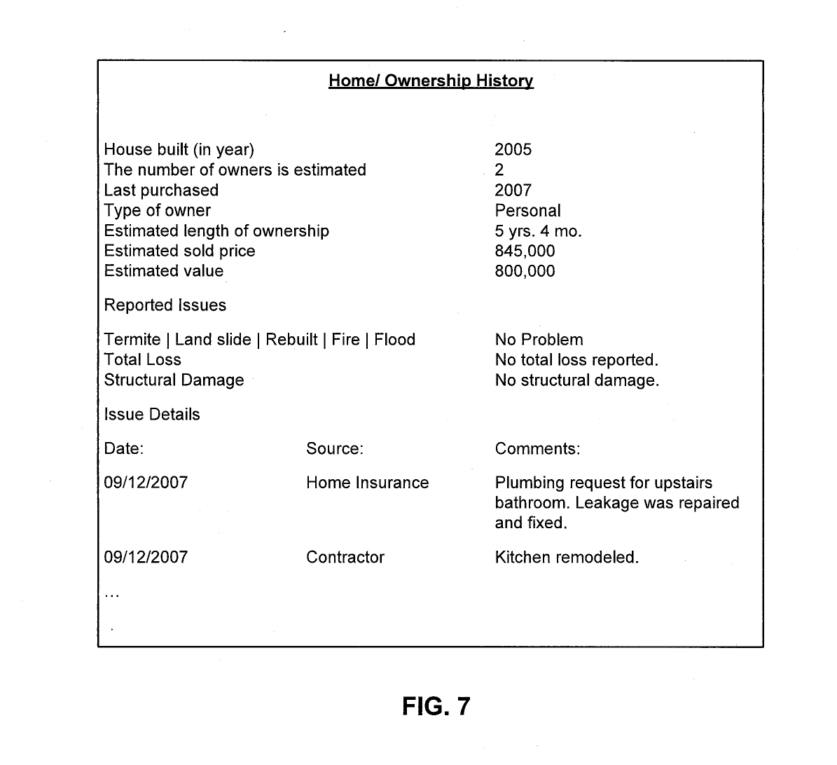

In one embodiment, certain detailed information of the projects completed by service providers can be captured and stored in property history database 131. The recorded information may include the date that project has been completed, a type of the project, and description of the project performed, etc. As described above, a report of a particular property may include the property improvement history, in addition to the general MLS information. The recorded property improvement history may further include information identifying a service provider that performed the job. However, dependent upon the specific situation, the report of the property may or may not include the service provider identity. For example, if the report is generated for the corresponding property owner, the report may identify the service provider that performed the job. However, if the report is generated for a general public member (e.g., a potential property buyer), the report may exclude the identity of the service provider. An example of a property report is shown in FIG. 7.

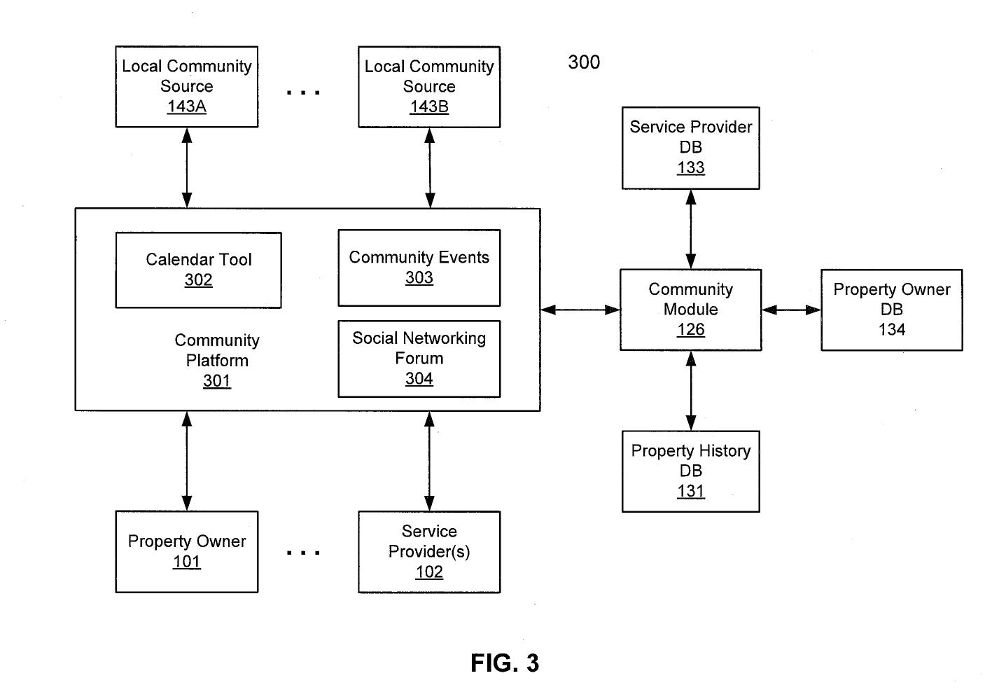

FIG. 3 is a block diagram illustrating an example of a community platform according to one embodiment of the invention. System 300 may be hosted by server 105 of FIG. 1. Referring to FIG. 3, in addition to providing property improvement market place, community module 126 provides community platform 301 to allow registered members of the system, such as property owners and service providers, to access neighborhood information provided by local community information sources 143A-143B. Community platform 301 may be presented as a Web page. Alternatively, the community information may be “pushed” to a user that has signed up or subscribed for receiving such information. In one embodiment, community module 126 communicates with community information sources 143A-143B to receive local community information such as local community events 303 (e.g., kids events) and post the information on community platform 301. In addition, community platform 301 provides calendar tool 302 to allow users to calendar community events 303. Community platform 301 may further provide social networking forum to allow the users to socialize with each other. The information presented by community platform 301 may be available only to the registered members of the system. Alternatively, some information such as community events 303 may be available to general public.

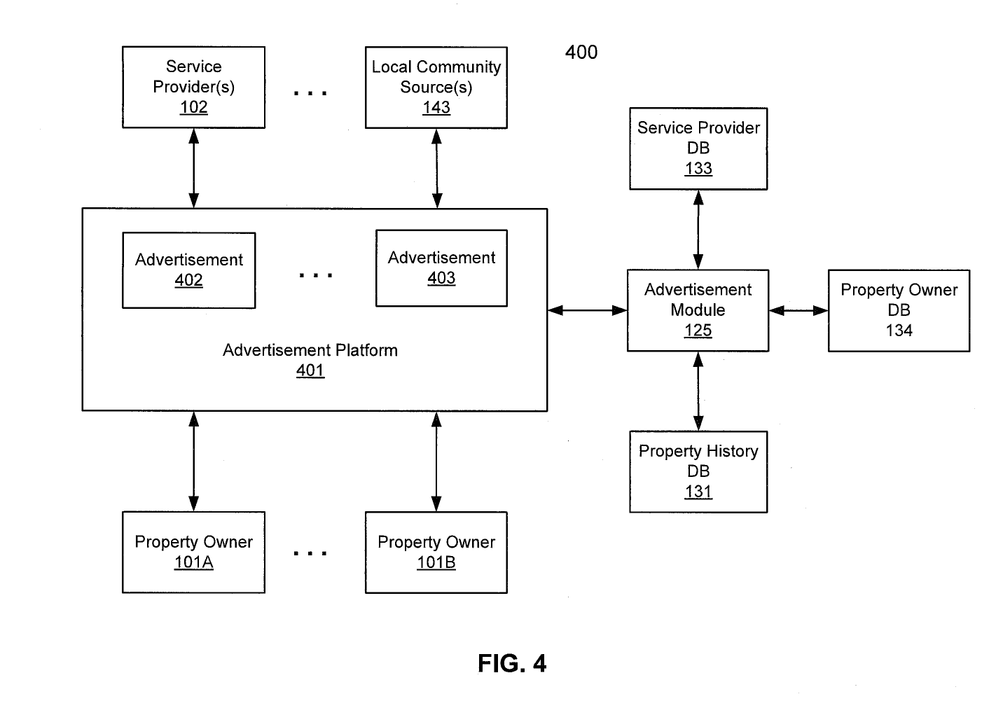

FIG. 4 is a block diagram illustrating an example of an advertisement platform according to one embodiment of the invention. System 400 may be hosted by server 105 of FIG. 1. Referring to FIG. 4, in this embodiment, an advertisement platform 401 is provided and managed by advertisement module 125. Advertisement platform 401 allows service providers and/or local communities 143 to post advertisements or promotions 402-403 to property owners 101A-101B to solicit further business opportunities. Advertisements 402-403 may be presented as a Web page that is accessible by all parties. Alternatively, advertisements 402-403 may be “pushed” to property owners 101A-101B, where a property owner can opt in or opt out for such advertisements. A property owner can set up a set of rules to selectively receive certain types of advertisements or receive advertisements from certain service providers.

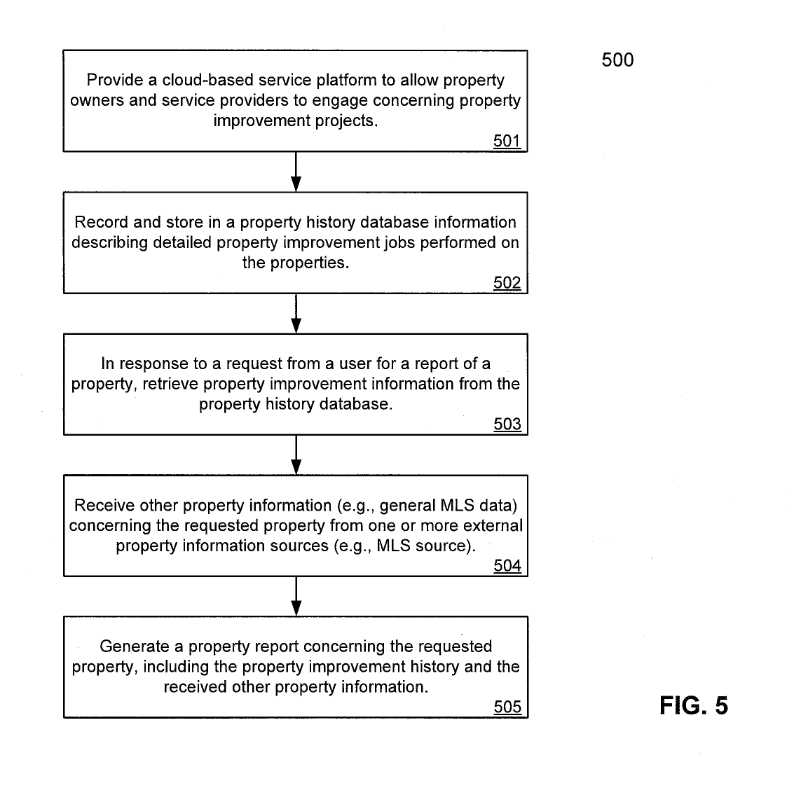

FIG. 5 is a flow diagram illustrating a method for providing property information including improvement history according to one embodiment of the invention. Method 500 may be performed by processing logic which may include software, hardware, or a combination thereof. For example, method 500 may be performed by server 105 of FIG. 1. Referring to FIG. 5, at block 501, a cloud-based service platform is provided to allow property owners and service providers to engage concerning property improvement projects. At block 502, processing logic records and stores in a property history database information describing detailed property improvement jobs performed on the properties. In response to a request from a user for a report of a property, processing logic retrieves property improvement information from the property history database. At block 504, processing logic receives other property information (e.g., general MLS data) concerning the requested property from one or more external property information sources (e.g., MLS sources). At block 505, a property report is generated for the requested property, including property improvement history and the other property information.

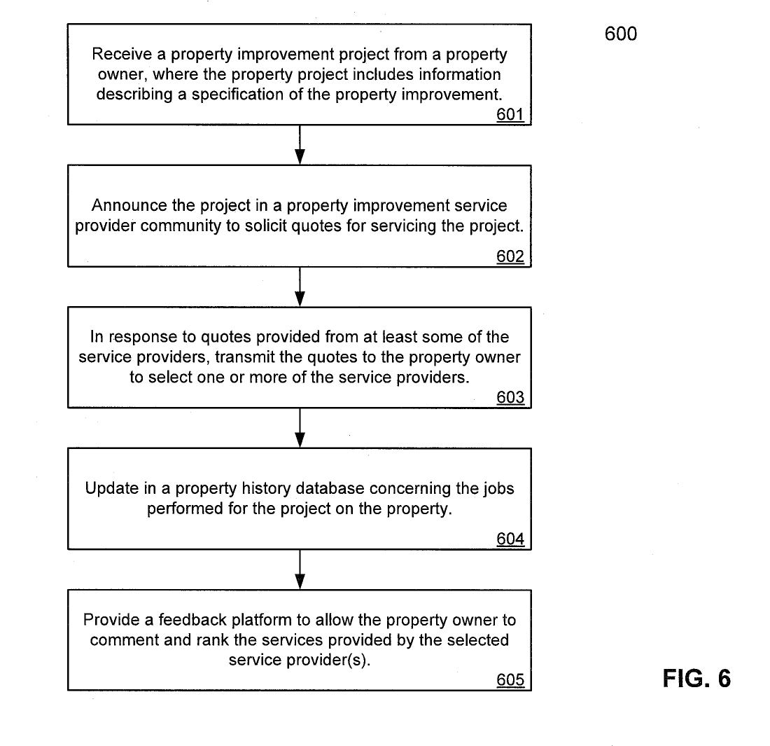

FIG. 6 is a flow diagram illustrating a method for providing property information including improvement history according to one embodiment of the invention. Method 600 may be performed by processing logic which may include software, hardware, or a combination thereof. For example, method 600 may be performed by server 105 of FIG. 1. Referring to FIG. 6, at block 601, processing logic receives a property improvement project from a property owner, where the property improvement project includes information describing a specification of the property improvement. At block 602, processing logic announces the project in a property improvement service provider community to solicit quote for servicing the project. In response to quotes received from at least some of the service providers, at block 603, processing logic transmits the quotes to the property owner to select one or more of the service providers. At block 604, processing logic updates in a property history database concerning the jobs performed for the property on the property. At block 605, a feedback platform or interface is provided to allow the property owner to comment and rate the services provided by the selected service provider(s).

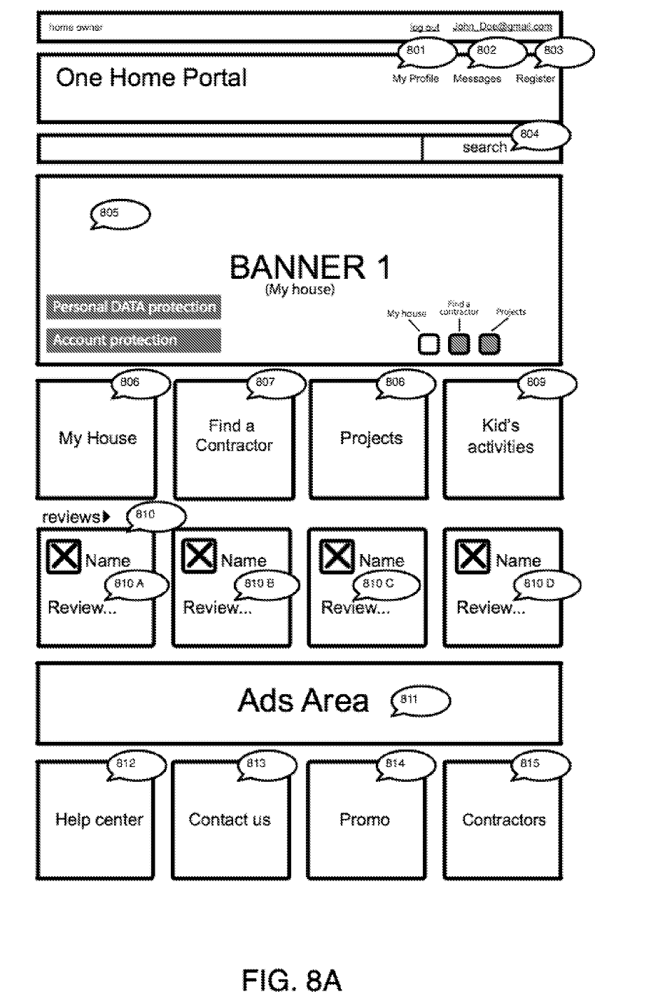

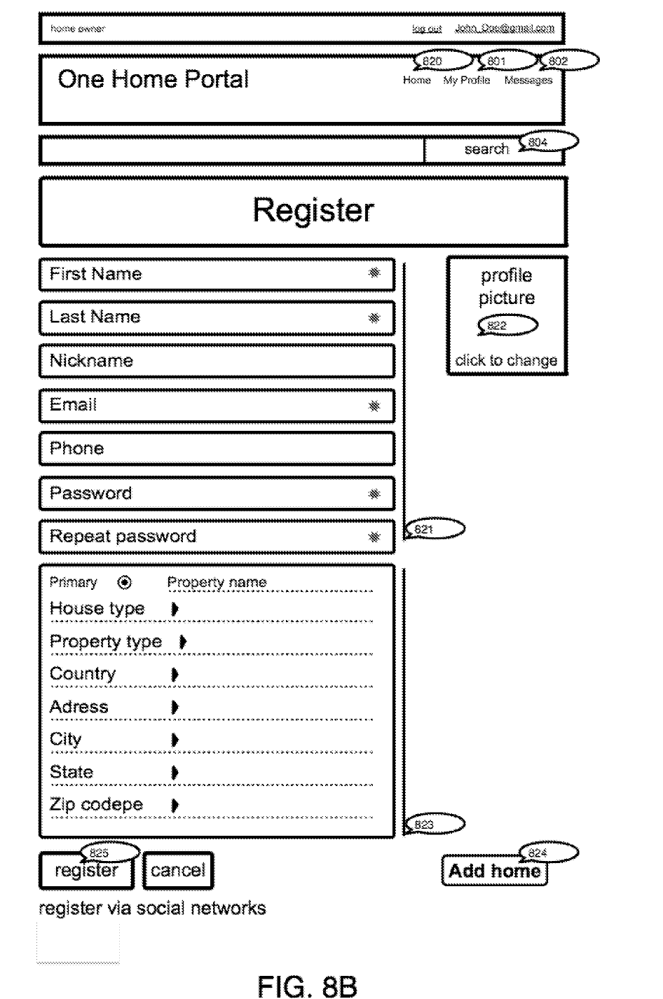

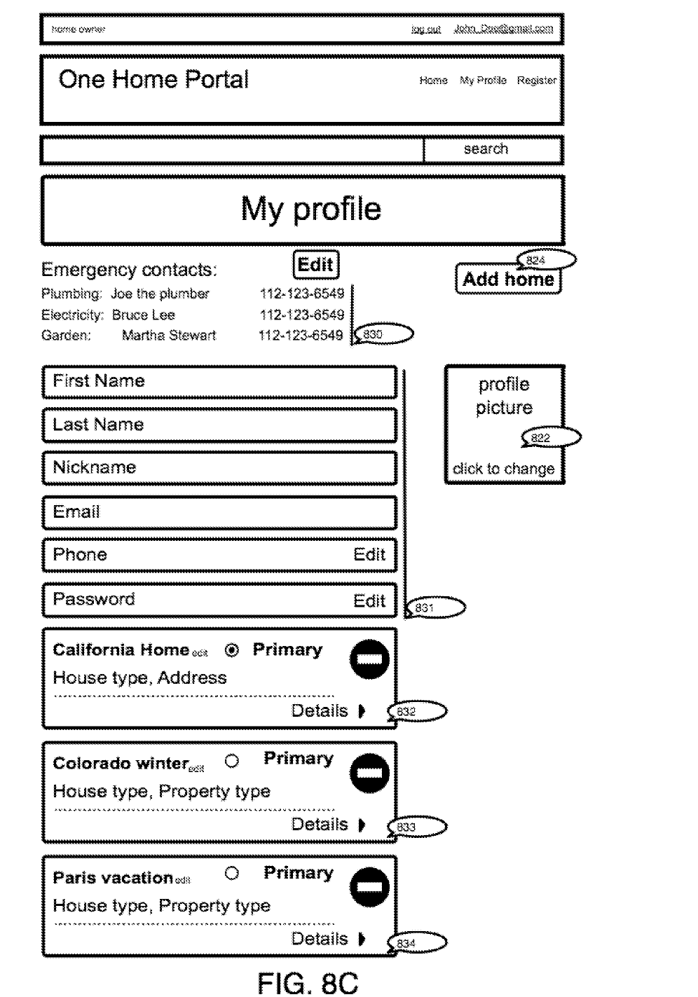

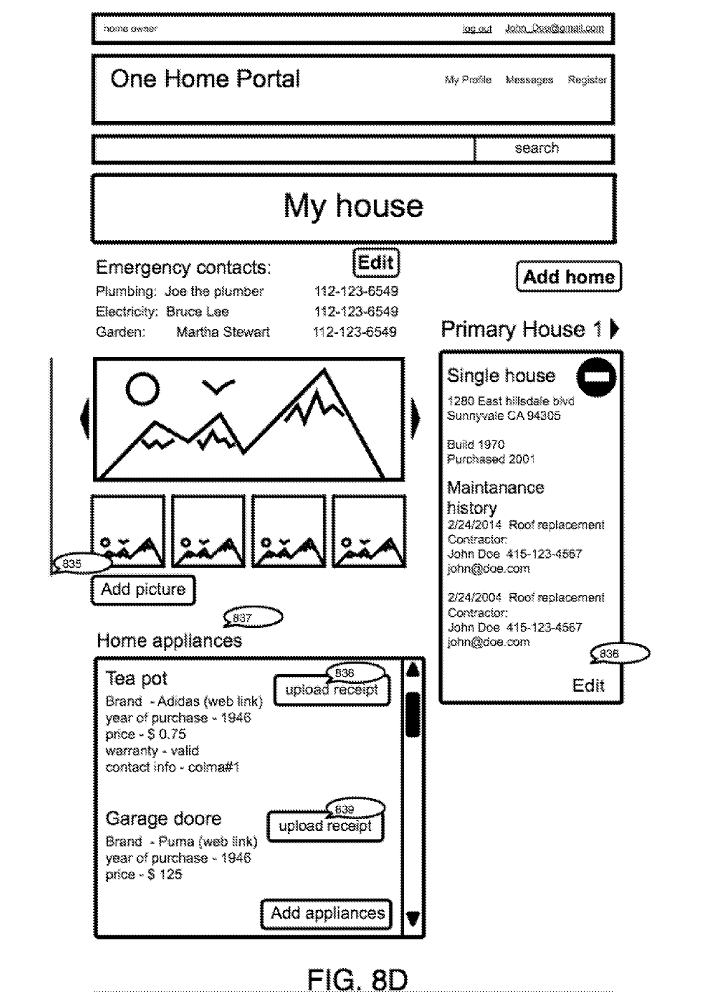

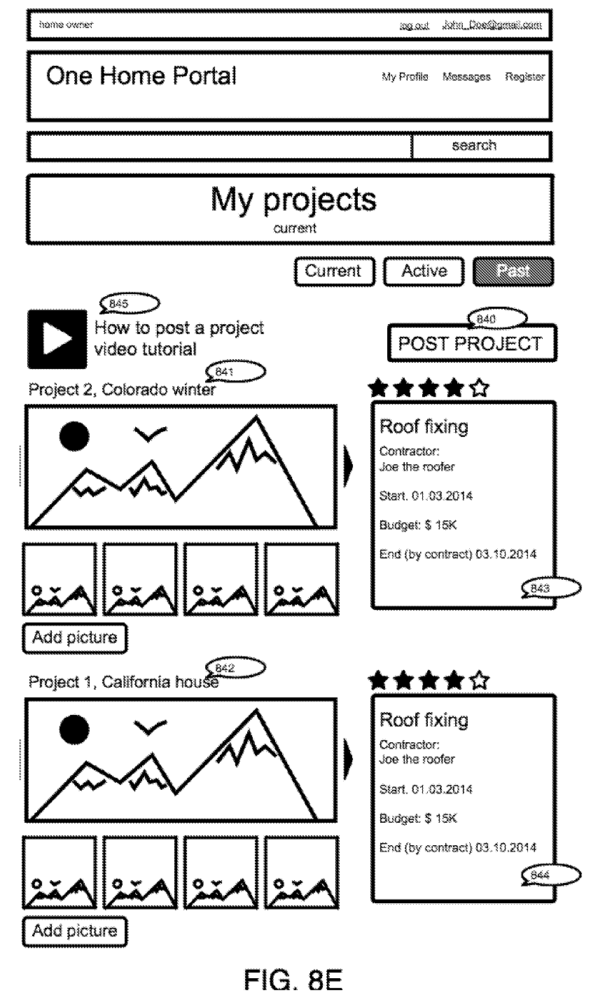

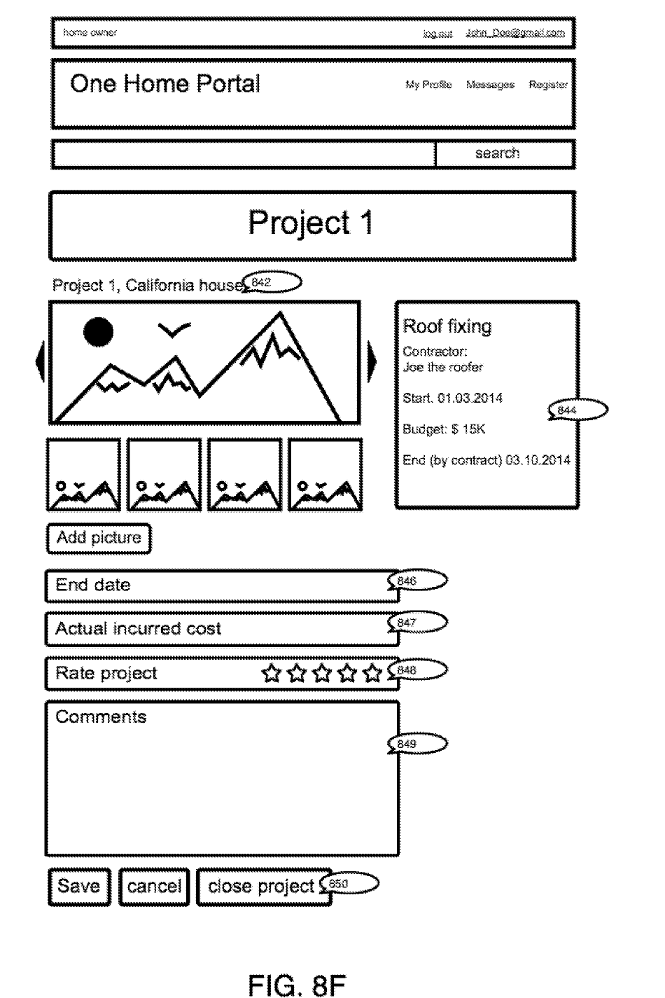

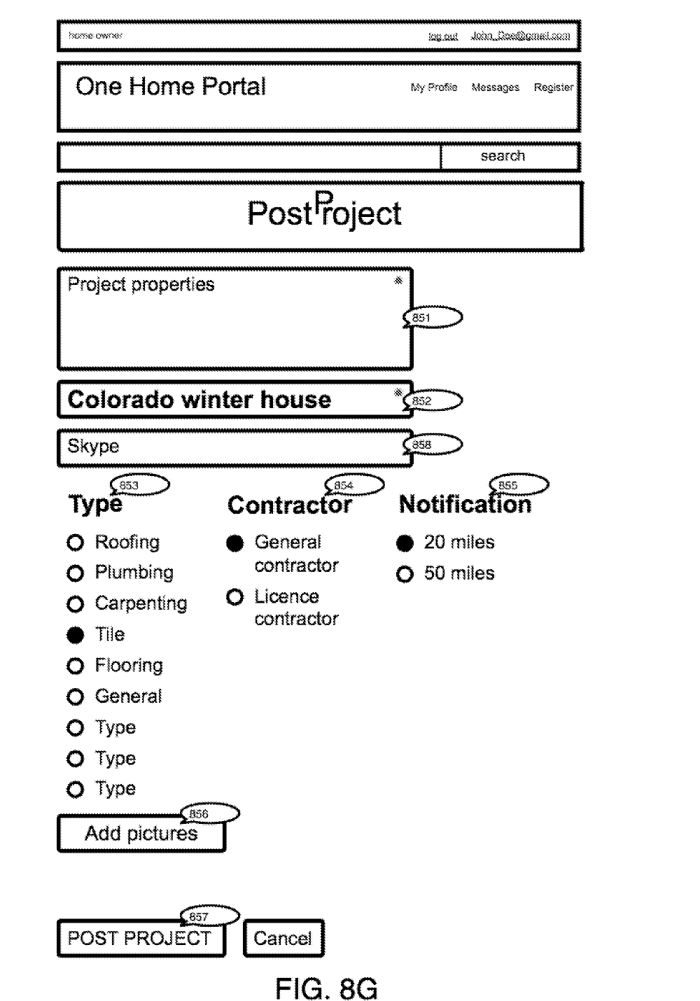

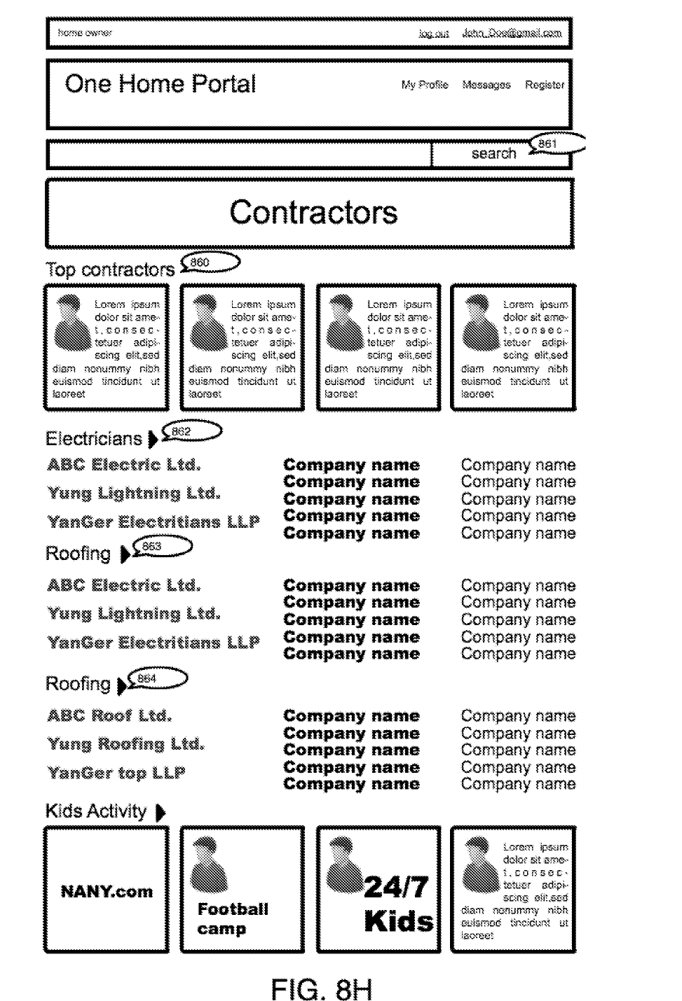

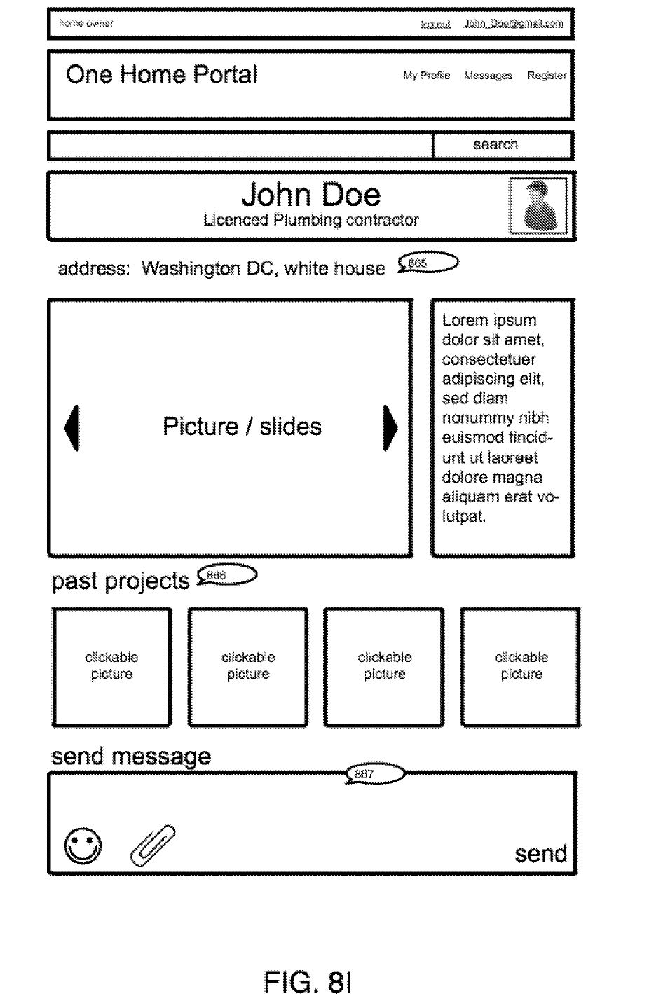

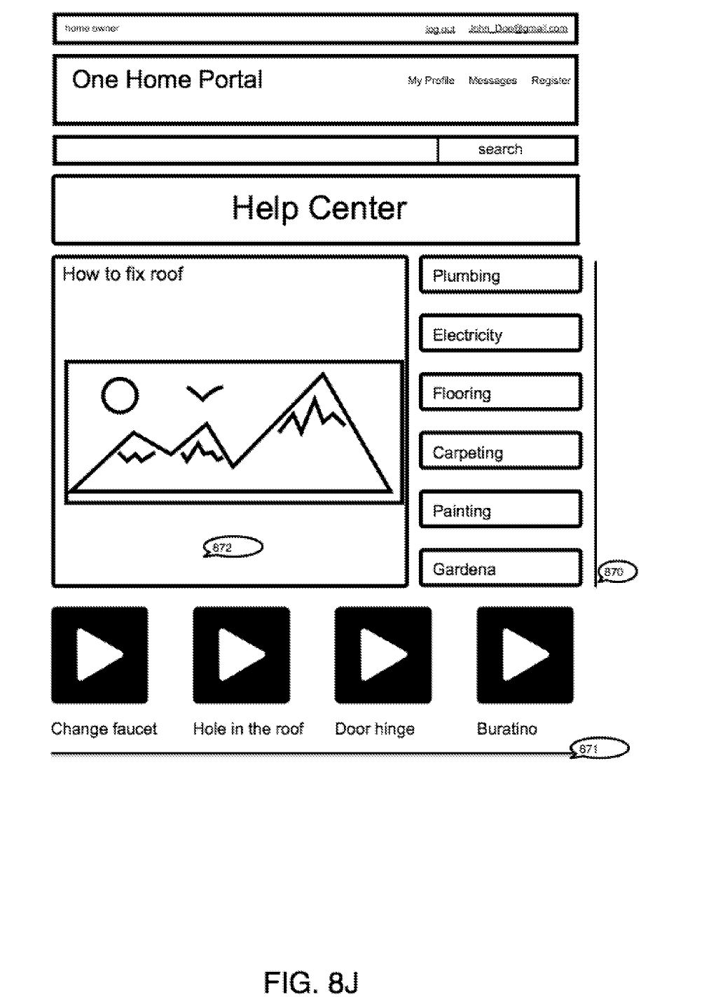

FIGS. 8A-8J are block diagrams illustrating examples of graphical user interfaces provided by a server according to one embodiment of the invention. The graphical user interface (GUI) described in FIGS. 8A-8J may be implemented as a part of user interface 110 provided by server 105 and presented at any of client devices 101-103 of FIG. 1. Referring to FIG. 8A, in this example, the GUI page as shown in FIG. 8A may be presented as a home page to a user who logs in and has been successfully authenticated (e.g., via security module 121) as a property owner at server 105 of FIG. 1. The home page may include various controls, which when activated, cause one or more commands to be transmitted from a client device to server 105 to perform one or more actions. A result of the actions may then be transmitted from server 105 back to the client device, which may be presented as a GUI page having the resulting data displayed therein. A control may be represented by a graphical representation such as an icon, a button, or a link. A control may be activated by an action of a pointing device (e.g., mouse), a key stroke, a voice interactive command, or a combination thereof.

In this example, the home page as shown in FIG. 8A includes control 801 to access a profile of a corresponding property owner, control 802 to access messages related to the property owner, and control 803 to register a property owned or managed by the property owner. The home page further includes a search function 804 (which may be handled by search engine 124 of FIG. 1) to allow the property owner to search a property, a service provider, or a local community event, etc. The home page further includes display area 805 to display general information of the property owner and/or its property or properties. Control 806 may be used to access information of a particular one or ones of the registered properties associated with the property owner. The property owner can activate control 807 to find a service provider of a particular type. The property owner can activate control 808 to browse one or more property improvement projects 808 associated with one or more properties of the property owner, which may be handled by project manager 122 of FIG. 1. Via control 809, the property owner can access any neighborhood events, in this example, the kid's activities, which may be managed by community module 126 of FIG. 1.

In one embodiment, the property owner can browse reviews via control 810 for all of the jobs related to its properties or alternatively, individually browse reviews via controls 810A-910D, which may be the most popular or recent reviews. Home page may further include an advertisement display area 811 to display any advertisements from a sponsor. A sponsor may be a service provider registered with the system or a general public sponsor, which may or may not be related to properties in general. The property owner can set up a set of advertisement delivery rules to allow certain types of advertisements to be displayed in display area 811, which may be managed by advertisement module 125 of FIG. 1. From control 812, the property owner can access a help center to browse certain self-help or DIY information, such as, for example, self-help KB 135 of FIG. 1. The property owner can also contact via control 813 an administrator of the hosting platform for any concern of its account, access via control 814 any promotions currently available at the platform, and access other service providers via control 815.

FIG. 8B is a registration page for register a property owner and a property according to one embodiment. The registration page can be presented in response to an activation of control 803 of FIG. 8A. From control 820, the user can go back to the home page as shown in FIG. 8A. In one embodiment, the registration page includes various fields 821 to allow the user to provide general information describing the user as a property owner, as well as a profile picture of the user via control 822. The registration page may require a property owner to register at least one property by providing information of the property via fields 823. An additional property may also be added via control 824. Once the user activates register button 825, the information entered in the registration page is stored in various databases of the system, such as, for example, property owner database 134, property history database 131, and/or MLS database 132 of FIG. 1. The system may further retrieve additional information based on the registration from an external source, such as, for example, MLS sources 141 of FIG. 1.

FIG. 8C is a profile page displaying profile information of a property owner according to one embodiment. The profile page may be presented in response to control 801. The profile page as shown in FIG. 8C may be used to displayed and/or edit the profile of the property owner. The profile of a property owner can include various information concerning the property owner and the property or properties associated with the property owner. In this example, the profile page as shown in FIG. 8C includes emergency contact information 830 of certain service providers that the property owner typically use to maintain its properties, such as, for example, a plumber, an electrician, and a gardener. The profile further includes general information 831 of the property owner, which may be registered via the registration page as shown in FIG. 8B. The profile page further lists one or more properties 832-834 associated with the property owner. An additional property may be added via control 824. Similarly, a registered property can also be removed from the profile by activating the corresponding remove button, in this example, a button with a minus sign.

The detailed information concerning any of the registered properties can be retrieved and displayed by activating the corresponding “details” link. FIG. 8D is a property page displaying detailed information of a registered property according to one embodiment. The property page may be presented in response to an activation of a “details” link of any of registered properties 832-834 or alternative, via control 806 of FIG. 8A. According to one embodiment, the property page includes display area 835 to allow a property owner to upload and display pictures associated with the property currently displayed. The property page further includes a display area 836 to display and edit general property information and property improvement history of the property. The information displayed in display area 836 may be used to generate at least a portion of property report as shown in FIG. 7.

In one embodiment, the property page further includes display area 837 to allow the property owner to list and edit property items associated with the property, such as appliances or equipment, etc. It also allows the property owner to upload the purchase receipt of the items, for example, via buttons 838-839. As a result, the property owner does not have to individually store the receipt or warranty information of the items. The system serves as a centralized bookkeeping system for the property owner.

As described above, a property owner can post a property improvement project in a property improvement market place (e.g., market place 250 of FIG. 2) to allow one or more service providers to compete for the project. A property owner can also browse the status and history of the property improvement projects performed by various service providers. FIG. 8E is a project page displaying one or more projects that have been posted by the property owner and/or completed or being completed by service providers. The project page may be presented in response to an activation of button 808 of FIG. 8A.

In one embodiment, in this example, the project page lists projects 841-842 associated with the property owner, which may be a current project, an active project, or a past project. A current project refers to a project that has been posted by a property owner. An active project refers to a project that has been posted by a property owner and open for bidding from service providers. For each of the listed projects 841-842, in addition to the pictures of the associated properties, project information of the projects is displayed in display areas 843-844. Project information includes an identity of a service provider who performs or performed the corresponding project, the cost of the project, the starting and ending dates of the project, and the user rating of the project (if it has been completed). From the project page, the property owner can post a new project via control 840. If the property owner is not familiar with how to pose a project, the property owner can access training material via control 845, where the training material may be maintained as part of self-learning KB 135 of FIG. 1.

The project information can be edited via the GUI page as shown in FIG. 8F. Referring to now to FIG. 8F, a property owner can provide detailed information regarding the project. For example, the property owner can provide the ending date of project via field 846, the actual cost via field 847, ratings via field 848, and comments via field 849. If the project is an active project, after providing the comments and ratings to the service provider, the property owner can close the project via button 850, which will transition the active project into a past or completed project. Alternatively, the property owner can simply update the information by clicking the “save” button, where the information will be stored in the corresponding database without changing the state of the project.

FIG. 8G is a block diagram illustrating an example of a GUI page for posting a project according to one embodiment of the invention. The GUI page as shown in FIG. 8G may be presented in response to an activation of button 840 of FIG. 8E. Referring to FIG. 8G, the GUI page includes a display area or field 851 to allow a property owner to a brief description of the project, field 852 to allow the property owner to select a registered property associated with the project, and field 858 to specify a communication mechanism (e.g., voice, chat, email) that the property owner can be reached. In addition, the property owner can select project type 853 (e.g., roofing, plumbing, tile, flooring, etc.), type of service providers 854, and geographical location of the service providers 855. The property owner can also attach one or more pictures of the associated property via button 856. The project can be posted by activating button 857. Once the project has been posted, the posted project can be viewed or searched via the property improvement market place 250 of FIG. 2 by the registered service providers. The service providers can compete for the project by submitting competing quotes, which may be handled by quote engine 210 of FIG. 2. The service providers can also communicate with the property owner via the preferred communications mechanism specified in field 858 concerning the posted project. Any of the communications between a service provider and the property owner may be recorded in property history database 131 of FIG. 1.

According to one embodiment, via the Web portal, a property owner can also browse or search service providers. FIG. 8H is a block diagram illustrating an example of a GUI page for browsing service providers according to one embodiment of the invention. The GUI page as shown in FIG. 8H may be presented in response to an activation of button 815 of FIG. 8A. Referring to FIG. 8H, in this example, the service provider page lists top service providers 860, which may be sorted based on a variety of categories, such as, for example, user ratings, geographical locations, or paid fees. A property owner can also search a particular type of service providers via search field 861. In addition, the service provider page may further list top service providers under different categories 862-864. The property owner can examine the detailed information concerning any of the listed service providers by clicking at that particular service provider, as shown in FIG. 8I.

FIG. 8I is a page displaying detailed information of a particular service provider. The service provider page includes general information 865 about the service provider, such as, name, address, and a short description. In addition, the service provider page further lists past projects 866 that the service provider has performed including the pictures of the properties associated with the projects. The information listed in the service provider page may be configurable by the corresponding service provider. A user such as a property owner can communicate with the service provider by sending a message via field 867.

FIG. 8J is a block diagram illustrating a graphical user interface for self-learning property improvement according to one embodiment of the invention. The GUI page as shown in FIG. 8J may be presented in response to an activation of button 812 of FIG. 8A. Referring to FIG. 8J, the information presented in the GUI may be retrieved from self-help KB 135 of FIG. 1. The GUI page includes self-learning material in a variety of forms, such as, for example, texts, slides, audio, video, or a combination thereof. In this example as shown in FIG. 8J, the self-learning material is provided in a form of video. The material may be presented in different categories 870. A user, such as a property owner, can browse the material or search a particular subject matter of the material. The most popular or most recently added videos may be listed in display area 871. When a user clicks on any one of the videos 871, the selected video will be played in display area 872.

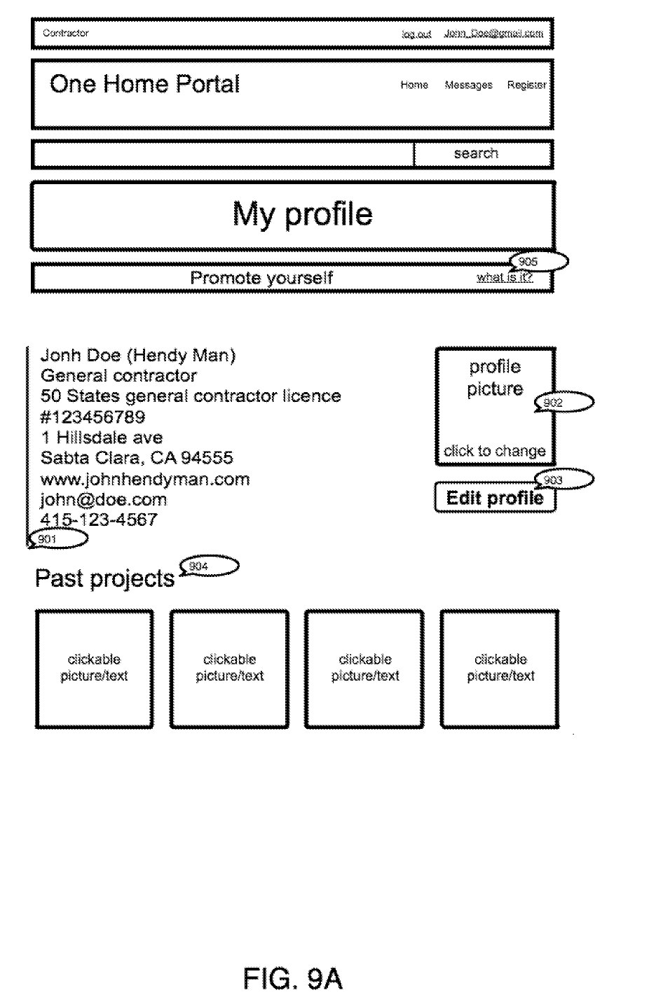

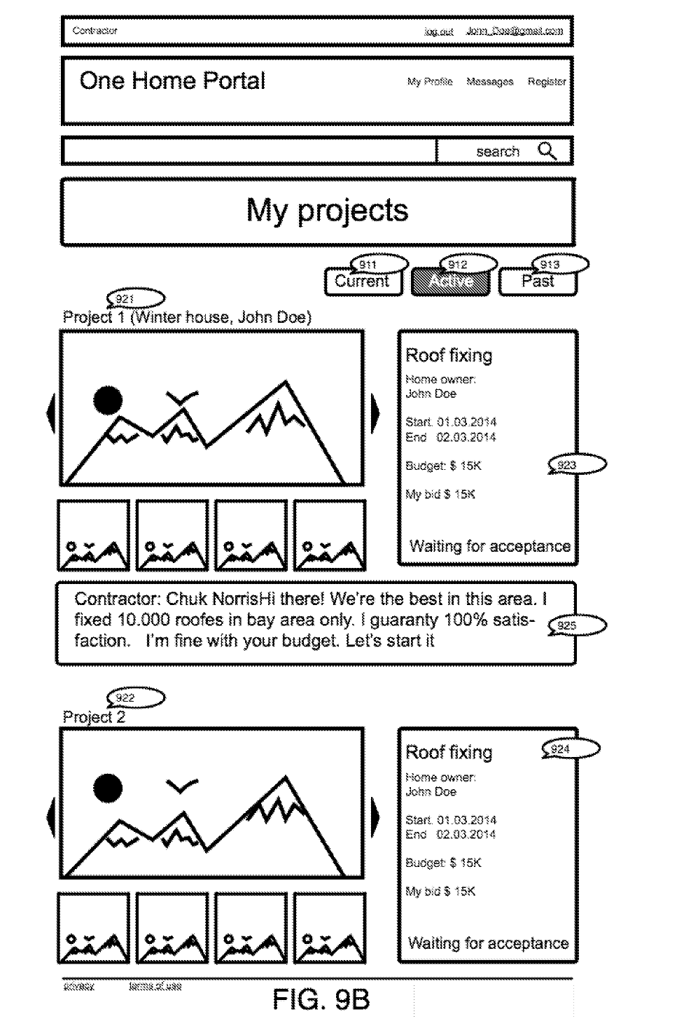

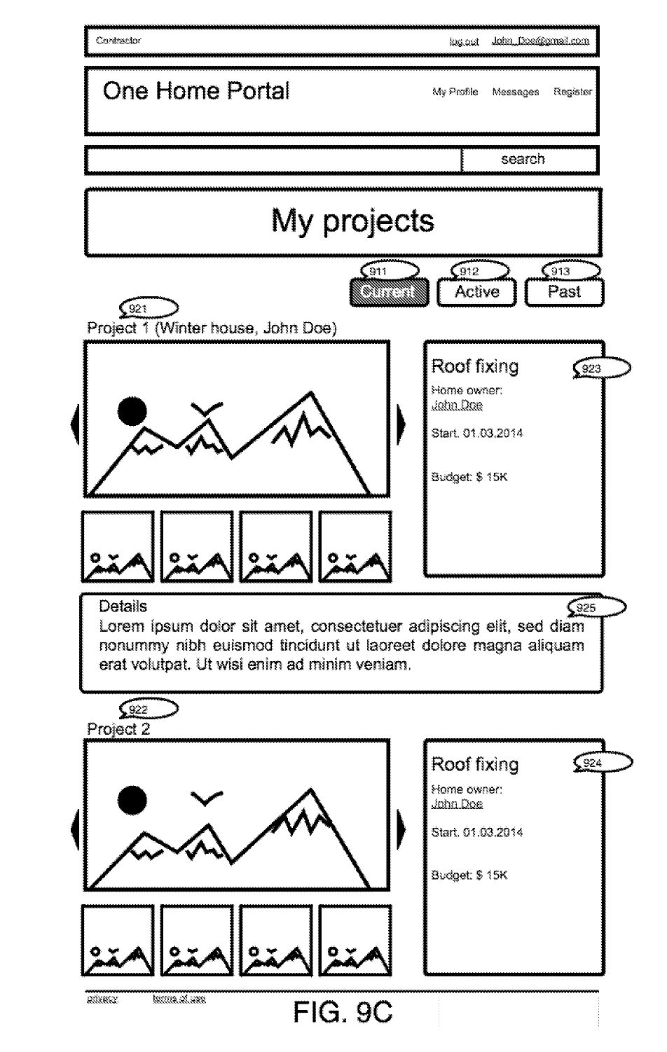

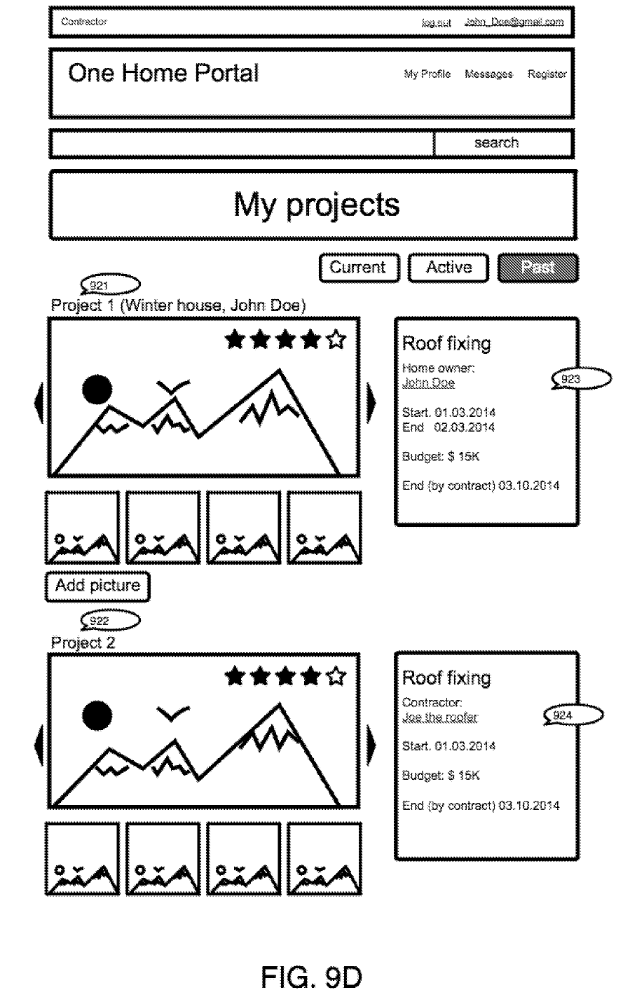

FIGS. 9A-9D are block diagrams illustrating examples of graphical user interfaces according to another embodiment of the invention. The graphical user interface (GUI) described in FIGS. 9A-9D may be implemented as a part of user interface 110 provided by server 105 and presented at any of client devices 101-103 of FIG. 1. In one embodiment, a home page of a service provider may be similar to a home page of a property owner, including general information about the service provider (which may be retrieved from the profile of the service provider) and a list of projects associated with the service provider. Referring to FIG. 9A, in this example, the GUI page as shown in FIG. 9A may be presented as a profile page to a user who logs in and has been successfully authenticated (e.g., via security module 121) as a service provider at server 105 of FIG. 1. Similar to a profile page of a property owner, the profile page of a service provider includes general information 901 about the service provider, including the contact information of the service provider and a profile picture or logo 902 of the service provider. The profile page may further include one or more projects 904 performed by the service provider in the past, which may be selected by the service provider to appear in the profile page. The service provider can also provide a brief description or promotion about the services it provides in field 905. Some or all of the information displayed in the home page may be edited via button 903 and stored in service provider database 133 of FIG. 1.

FIG. 9B is a block diagram illustrating an example of graphical user interface displaying projects of a service provider according to one embodiment. The GUI page may be presented in response to an activation from a home page of the service provider for displaying projects of the service provider. From the project page as shown in FIG. 9B, a service provider can access a current project via button 911, an active project via button 912, and a past project via button 913 associated with the service provider.

In this example, projects 921-922 are part of active projects presented in response to an activation of button 912. For each of the active projects, the GUI page displays brief information of the project in display areas 923-924 and pictures of the properties, respectively. The project information may include the starting and ending dates of the bidding period, as well as the budget, provided by a property owner. The project information further includes a bidding amount submitted by the corresponding service provider, as well as the status of the active project, in this example, waiting for acceptance of the property owner. The service provider can also provide further advertisement or promotion in field 925 for project 921. FIG. 9C is a block diagram illustrating a graphical user interface displaying current projects according to another embodiment of the invention. The GUI page as shown in FIG. 9C may be presented in response to an activation of button 911. Similar to the GUI page as shown in FIG. 9B, the GUI page lists all the projects associated with the service provider that are in a current state. FIG. 9D is a block diagram illustrating a GUI page displaying past projects according to another embodiment of the invention. In the GUI page as shown in FIG. 9D, the project information of a past project further includes the ending date of the project completed by a service provider and accepted by a property owner.

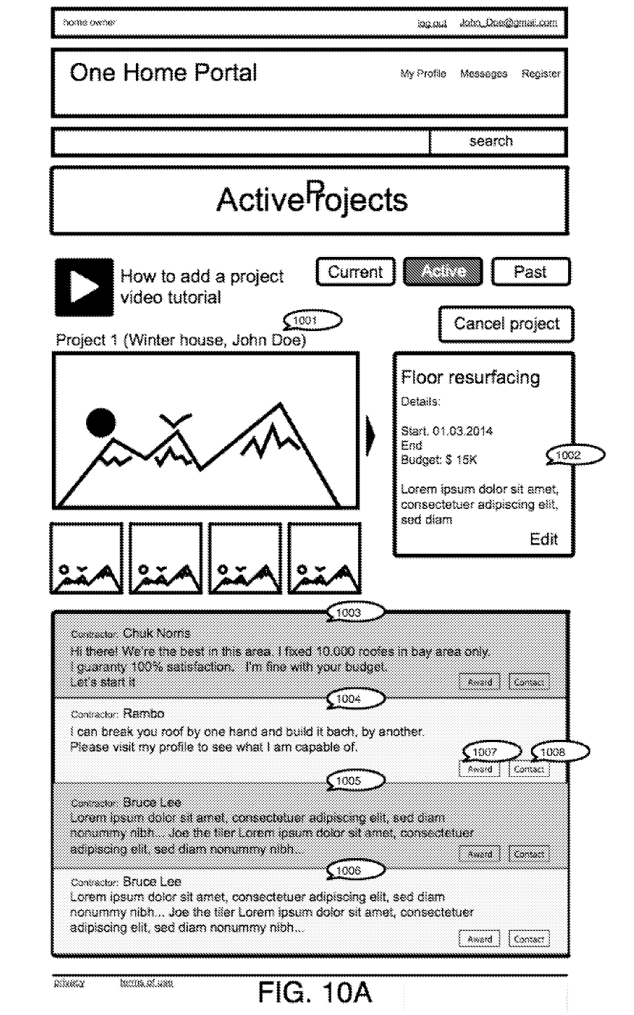

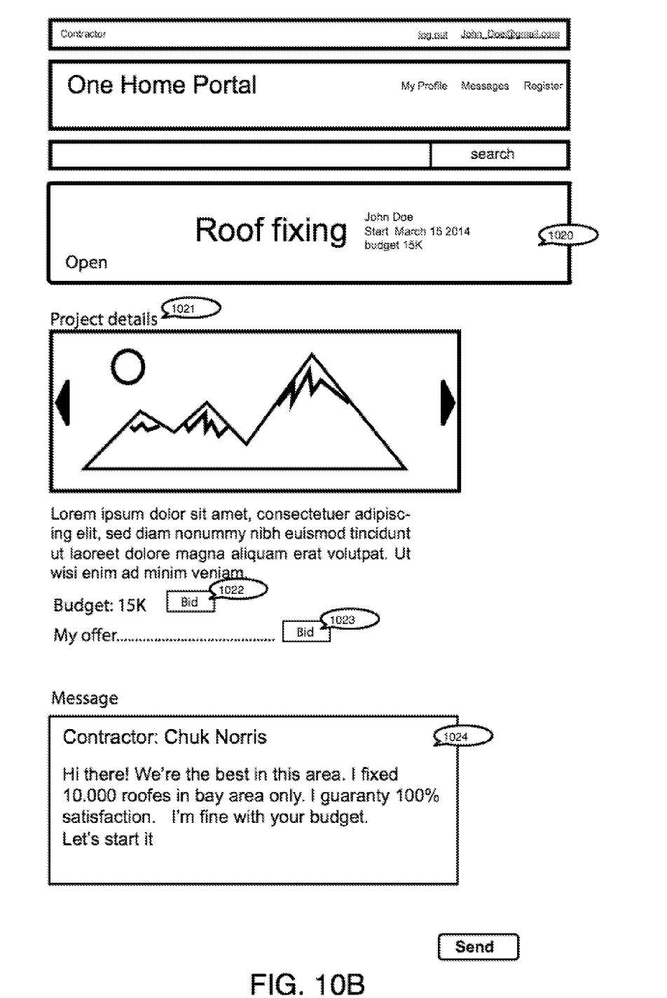

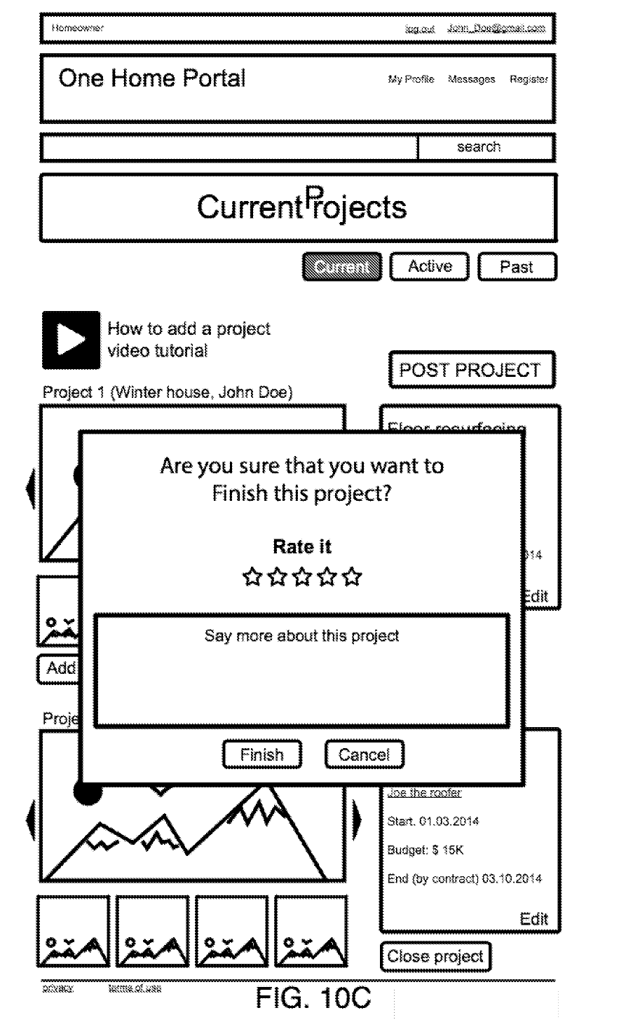

FIGS. 10A-10C are block diagrams illustrating examples of graphical user interfaces regarding communications between a property owner and a service provider according to one embodiment of the invention. FIGS. 10A-10C may be presented by property improvement market place 250 of FIG. 2. Referring to FIG. 10A, the GUI page represents an active project page in which a property improvement project has been opened for bidding by the corresponding property owner. In this example, project 1001 is an active project whose information is displayed in display area 1002, including the budget set forth by the property owner. In addition, in this example, multiple bids 1003-1006 have been received from different service providers. The bidding information may include a bid amount and a brief description or promotion from each of the bidding service providers. The property owner can award any one of the service providers, for example, by clicking award button 1007. Alternatively, the property owner can contact any of the bidding service providers, for example, by clicking contact button 1008.

Referring now to FIG. 10B, the GUI page as shown is an active project page of a service provider. In this example, an active project 1020 is displayed including the detailed project information 1021. The detailed information 1021 includes a budge set forth by a property owner when the property owner posted the project. The service provider can bid on the project to match the budge via button 1022 or alternatively, provide a best offer via button 1023. The service provider can also provide a brief description or message to the property owner in field 1024. Once the project has been awarded to a service provider and completed by the awarded service provider, the property owner can provide feedbacks to the service provider as shown in FIG. 10C. Note that the GUI pages as shown in FIGS. 8A-8J, 9A-9D, and 10A-10C are described and shown for the purpose of illustration only; other formats or layouts may also be applied.

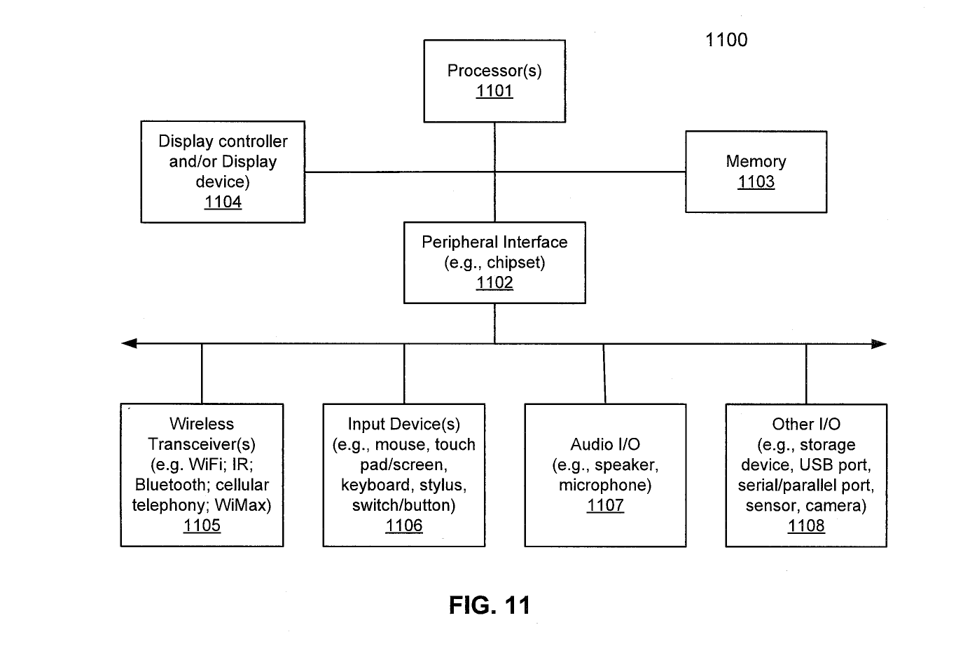

FIG. 11 is a block diagram illustrating an example of a data processing system which may be used with one embodiment of the invention. System 1100 may represents any of data processing systems described above performing any of the processes or methods described above. For example, system 1100 may represent server 105 or any of client devices 101-103 of FIG. 1. System 1100 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof.

Referring to FIG. 11, in one embodiment, system 1100 includes processor 1101 and peripheral interface 1102, also referred to herein as a chipset, to couple various components to processor 1101 including memory 1103 and devices 1105-1108 via a bus or an interconnect. Processor 1101 may represent a single processor or multiple processors with a single processor core or multiple processor cores included therein. Processor 1101 may represent one or more general-purpose processors such as a microprocessor, a central processing unit (CPU), or the like. More particularly, processor 1101 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1101 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 1101 is configured to execute instructions for performing the operations and steps discussed herein.

Peripheral interface 1102 may include memory control hub (MCH) and input output control hub (ICH). Peripheral interface 1102 may include a memory controller (not shown) that communicates with a memory 1103. Peripheral interface 1102 may also include a graphics interface that communicates with graphics subsystem 1104, which may include a display controller and/or a display device. Peripheral interface 1102 may communicate with graphics device 1104 via an accelerated graphics port (AGP), a peripheral component interconnect (PCI) express bus, or other types of interconnects.

An MCH is sometimes referred to as a Northbridge and an ICH is sometimes referred to as a Southbridge. As used herein, the terms MCH, ICH, Northbridge and Southbridge are intended to be interpreted broadly to cover various chips who functions include passing interrupt signals toward a processor. In some embodiments, the MCH may be integrated with processor 1101. In such a configuration, peripheral interface 1102 operates as an interface chip performing some functions of the MCH and ICH. Furthermore, a graphics accelerator may be integrated within the MCH or processor 1101.

Memory 1103 may include one or more volatile storage (or memory) devices such as random access memory (RAM), dynamic RAM (DRAM), synchronous DRAM (SDRAM), static RAM (SRAM), or other types of storage devices. Memory 1103 may store information including sequences of instructions that are executed by processor 1101, or any other device. For example, executable code and/or data of a variety of operating systems, device drivers, firmware (e.g., input output basic system or BIOS), and/or applications can be loaded in memory 1103 and executed by processor 1101. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 1102 may provide an interface to IO devices such as devices 1105-1108, including wireless transceiver(s) 1105, input device(s) 1106, audio IO device(s) 1107, and other IO devices 1108. Wireless transceiver 1105 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 1106 may include a mouse, a touch pad, a touch sensitive screen (which may be integrated with display device 1104), a pointer device such as a stylus, and/or a keyboard (e.g., physical keyboard or a virtual keyboard displayed as part of a touch sensitive screen). For example, input device 1106 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 1107 may include a speaker and/or a microphone to facilitate voice-enabled functions, such as voice recognition, voice replication, digital recording, and/or telephony functions. Other optional devices 1108 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 1108 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 11 illustrates various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, comprising:
providing a cloud-based platform at a server to allow a plurality of property owners to engage with a plurality of property service providers regarding property improvement projects to be performed on a plurality of properties of the property owners;
recording in a property history database, by a project manager, information describing tasks of the property improvement projects performed by the property service providers;
in response to a request received from a user for information concerning a first of the plurality properties, retrieving property improvement history data of the first property from the property history database; and
generating, by a reporting module, a property report for the first property, the property report including general multi-listing service (MLS) information and the property improvement history of the first property.

2. The method of claim 1, further comprising retrieving the general MLS information via an application programming interface (API) from an external MLS system over a network.

3. The method of claim 1, wherein providing a cloud-based platform to allow property owners to engage with the property service providers comprises:
receiving a job request of a property improvement project from a first of property owner associated with the first property, the job request describing a specification of the property improvement project;
announcing the job request in a service provider community associated with the property service providers to solicit service offers;
in response to one or more service offers received from one or more of the property service providers, transmitting the one or more service offers to the first property owner to select one or more of the service offers; and
capturing in the property history database detailed information concerning any of the offered services performed on the first property.

4. The method of claim 1, further comprising:
receiving from a first of the property service providers a promotion of a property improvement service;
announcing the promotion in a property owner community associated with the property owners; and
providing a communications mechanism to allow a second of the property owners to negotiate with the first property service provider concerning the promotion.

5. The method of claim 4, further comprising capturing negotiation information between the first property service provider and the second property owner in the property history database.

6. The method of claim 1, further comprising:
in response to a request received from a second property owner for neighborhood community information, identifying a geographical location of the second property;
retrieving neighborhood information from one or more external information sources associated with a neighborhood community representing the geographical location of the second property; and
transmitting the neighborhood information to the second property owner for presentation, including displaying one or more community events of neighborhood community.

7. The method of claim 6, further comprising providing a calendar tool to allow the second property owner to schedule at least one of the community events.

8. The method of claim 1, further comprising maintaining a self-learning knowledgebase (KB) for storing information concerning property improvement information that allow a user to search and browse do-it-yourself (DIY) information for property improvement.

9. A non-transitory computer-readable medium having instructions stored therein, which when executed by a computer, cause the computer to perform operations, the operations comprising:
providing a cloud-based platform at a server to allow a plurality of property owners to engage with a plurality of property service providers regarding property improvement projects to be performed on a plurality of properties of the property owners;
recording in a property history database, by a project manager, information describing tasks of the property improvement projects performed by the property service providers;
in response to a request received from a user for information concerning a first of the plurality properties, retrieving property improvement history data of the first property from the property history database; and
generating, by a reporting module, a property report for the first property, the property report including general multi-listing service (MLS) information and the property improvement history of the first property.

10. The non-transitory computer-readable medium of claim 9, wherein the operations further comprise retrieving the general MLS information via an application programming interface (API) from an external MLS system over a network.

11. The non-transitory computer-readable medium of claim 9, wherein providing a cloud-based platform to allow property owners to engage with the property service providers comprises:
receiving a job request of a property improvement project from a first of property owner associated with the first property, the job request describing a specification of the property improvement project;
announcing the job request in a service provider community associated with the property service providers to solicit service offers;
in response to one or more service offers received from one or more of the property service providers, transmitting the one or more service offers to the first property owner to select one or more of the service offers; and
capturing in the property history database detailed information concerning any of the offered services performed on the first property.

12. The non-transitory computer-readable medium of claim 9, wherein the operations further comprise:
receiving from a first of the property service providers a promotion of a property improvement service;
announcing the promotion in a property owner community associated with the property owners; and
providing a communications mechanism to allow a second of the property owners to negotiate with the first property service provider concerning the promotion.

13. The non-transitory computer-readable medium of claim 12, wherein the operations further comprise capturing negotiation information between the first property service provider and the second property owner in the property history database.

14. The non-transitory computer-readable medium of claim 9, wherein the operations further comprise:
in response to a request received from a second property owner for neighborhood community information, identifying a geographical location of the second property;
retrieving neighborhood information from one or more external information sources associated with a neighborhood community representing the geographical location of the second property; and
transmitting the neighborhood information to the second property owner for presentation, including displaying one or more community events of neighborhood community.

15. The non-transitory computer-readable medium of claim 14, wherein the operations further comprise providing a calendar tool to allow the second property owner to schedule at least one of the community events.

16. The non-transitory computer-readable medium of claim 9, wherein the operations further comprise maintaining a self-learning knowledgebase (KB) for storing information concerning property improvement information that allow a user to search and browse do-it-yourself (DIY) information for property improvement.

17. A data processing system, comprising:
a processor; and
a memory coupled to the processor for storing instructions, which when executed from the memory, cause the processor to perform operations, the operations including
providing a cloud-based platform to allow a plurality of property owners to engage with a plurality of property service providers regarding property improvement projects to be performed on a plurality of properties of the property owners,
recording in a property history database, by a project manager, information describing tasks of the property improvement projects performed by the property service providers,
in response to a request received from a user for information concerning a first of the plurality properties, retrieving property improvement history data of the first property from the property history database, and
generating, by a reporting module, a property report for the first property, the property report including general multi-listing service (MLS) information and the property improvement history of the first property.

18. The system of claim 17, wherein the general MLS information is retrieved via an application programming interface (API) from an external MLS system over a network.

19. The system of claim 17, wherein providing a cloud-based platform to allow property owners to engage with the property service providers comprises:
receiving a job request of a property improvement project from a first of property owner associated with the first property, the job request describing a specification of the property improvement project;
announcing the job request in a service provider community associated with the property service providers to solicit service offers;
in response to one or more service offers received from one or more of the property service providers, transmitting the one or more service offers to the first property owner to select one or more of the service offers; and
capturing in the property history database detailed information concerning any of the offered services performed on the first property.

20. The system of claim 17, wherein the operations further comprise:
receiving from a first of the property service providers a promotion of a property improvement service;
announcing the promotion in a property owner community associated with the property owners; and
providing a communications mechanism to allow a second of the property owners to negotiate with the first property service provider concerning the promotion.
